(19) United States
(12) Patent Application Publication
(10) Pub. No.: US 2007/0051320 A1
(43) Pub. Date: Mar. 8, 2007

(54) Dirt sucker for an aquarium

(76) Inventor: Yung-Hsin Yen, Hsia Ying Hsiang (TW)

Correspondence Address: Yung-Hsin YEN, P.O. Box 90, Tainan City, 70499, TW

(21) Appl. No.: 11/220,532

(22) Filed: Sep. 8, 2005

(51) Int. Cl. A01K 63/04

(52) U.S. Cl. 119/264; 210/167.23

(57) ABSTRACT

A dirt sucker for an aquarium includes mainly a compressing ball, a flexible long tube and a residue collector. The compressing ball is provided with a valve in its two ends respectively and connected with a short tube extending outwards at the two ends respectively. One of the tubes is connected with an adjustable switch for controlling flow rate or temporarily stopping suction. The flexible long tube is connected with one of the short tubes at one end. The residue collector, connected with the flexible long tube, is to be inserted among stones placed on the bottom of an aquarium to let dirt accumulated on the stones sucked out together with the water in the aquarium by repeated compression of the compressing ball, and the residue collector is provided with a filter in the interior.

### BACKGROUND OF THE INVENTION

1. Field of the Invention

This invention relates to a dirt sucker for an aquarium, particularly to one that is composed of a compressing ball, a flexible long tube and a residue collector. The compressing ball is provided with a valve in two ends respectively and connected with a short tube extending outwards at the two ends respectively. One of the tubes is connected with an adjustable switch for controlling flow rate or temporarily stopping suction. The flexible long tube is connected with one of the short tubes at its one end. The residue collector, connected with the flexible long tube, is to be inserted among the stones on the bottom of an aquarium to let dirt accumulated on the stones placed on the bottom of the aquarium sucked up mixed in the water and flowing through the flexible long tube, the compressing ball, the adjustable switch and exhausted out by repeated compression of the compressing ball, and is provided with a filter in its interior.

2. Description of the Prior Art

Usually, a conventional sucking device for an aquarium has a plastic film valve attached at its exit, preventing water sucked out from flowing backward. In using, water is sucked out by compressing a rubber ball. But, such a single film valve can't completely keep water from flowing backward as soon as compressing against the rubber ball is stopped. Besides, the conventional sucking device cannot control the flow rate and take a temporary pause. What is worse, it may suck out not only dirt but also some stones or plants placed therein for viewing at the same time, possible to clog up the tube. So this invention has been devised to improve the defects mentioned above.

### SUMMARY OF THE INVENTION

The prime object of this invention is to offer a dirt sucker for an aquarium, able to control flow rate or stop suction and clean up the dirt in the aquarium.

The main characteristics of the invention are a compressing ball, a flexible long tube and a residue collector. The compressing ball is provided with a valve in two ends respectively and connected with a short tube extending outwards at the two ends respectively. One of the short tubes is connected with an adjustable switch for controlling flow rate or temporarily stopping suction. The flexible long tube is connected with the other of the short tubes at its one end. The residue collector, connected with the flexible long tube, is to be inserted among the stones on the bottom of an aquarium to let dirt accumulated on the stoned placed on the bottom of the aquarium sucked through the flexible long tube, the compressing ball, the adjustable switch and then exhausted out of the aquarium by repeated compression of the compressing ball, and the residue collector is provided with a filter in the interior.

### BRIEF DESCRIPTION OF DRAWINGS

This invention is better understood by referring to the accompanying drawings, wherein:

FIG. 1 is an exploded perspective view of a preferred embodiment of a dirt sucker for an aquarium in the present invention;

FIG. 2 is a perspective view of the preferred embodiment of a dirt sucker in the present invention;

FIG. 3 is a cross-sectioned view of the preferred embodiment of a dirt sucker in the present invention; and

FIG. 4 is a perspective view of the preferred embodiment of a dirt sucker in the present invention, showing it under using.

### DETAILED DESCRIPTION OF THE PREFERRED EMBODIMENT

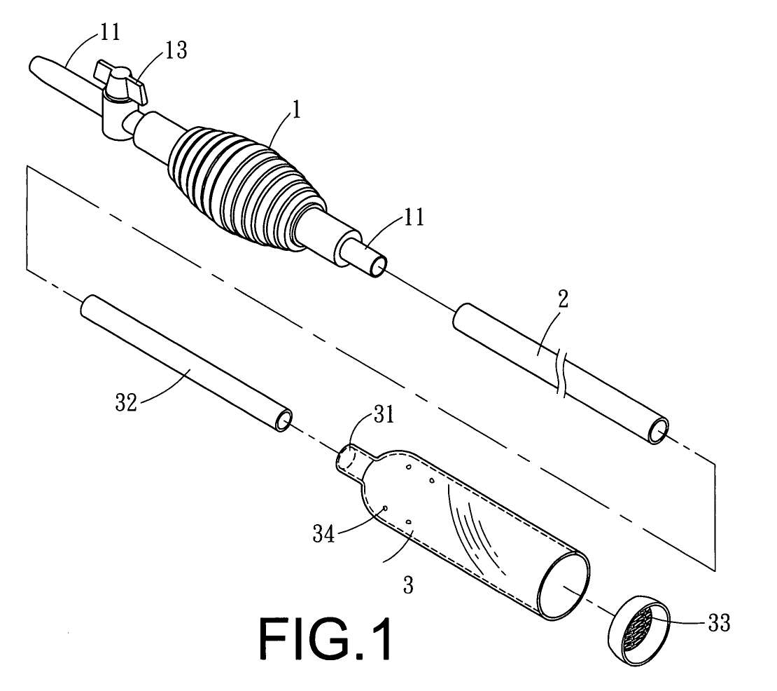

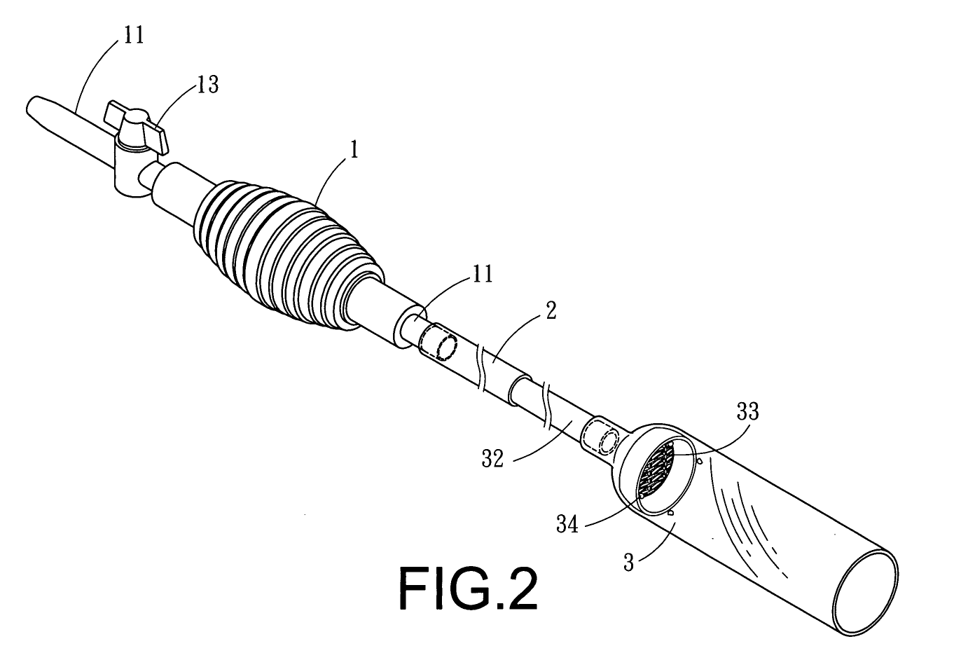

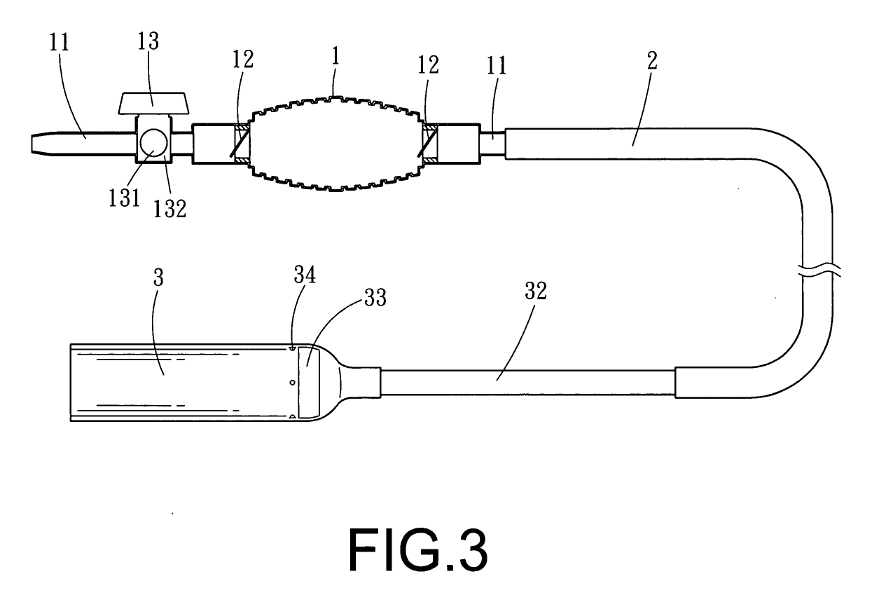

First, as shown in FIGS. 1-3, a preferred embodiment of a dirt sucker for an aquarium in the present invention includes a compressing ball 1, a flexible long tube 2 and a residue collector 3.

The compressing ball 1, shaped spherical and compressible, is connected with a short tube 11 at two ends respectively. Each of the short tubes 11 is set with a one-way valve 12 inside it at the spot where it is connected with the compressing ball 1, so as to control water to flow only in one direction, that is in the outward way. One of the short tubes 11 is connected with an adjustable switch 13, having a shank 132 with a passage 131 formed in a lower portion, for controlling flow rate and temporarily stopping suction.

The flexible long tube 2 is connected with one of the short tubes 11 at one end.

The residue collector 3, connected with the flexible long tube 2 to indirectly link with the compressing ball 1, is provided to be inserted among stones placed on the bottom of an aquarium to let dirt or residue accumulated on the stones sucked out together with water through the flexible long tube 2, the compressing ball 1 and the adjustable switch 13 and then exhausted out of the aquarium by compression of the compressing ball 1. One end of the residue collector 3 is provided with a connecting head 31 for connecting with a duct 32 connected to the flexible long tube 2. And, a filter 33 is set inside the residue collector 3, having plural projections 34 attached on an inner wall for fixing stably the filter 33 in the residue collector 3.

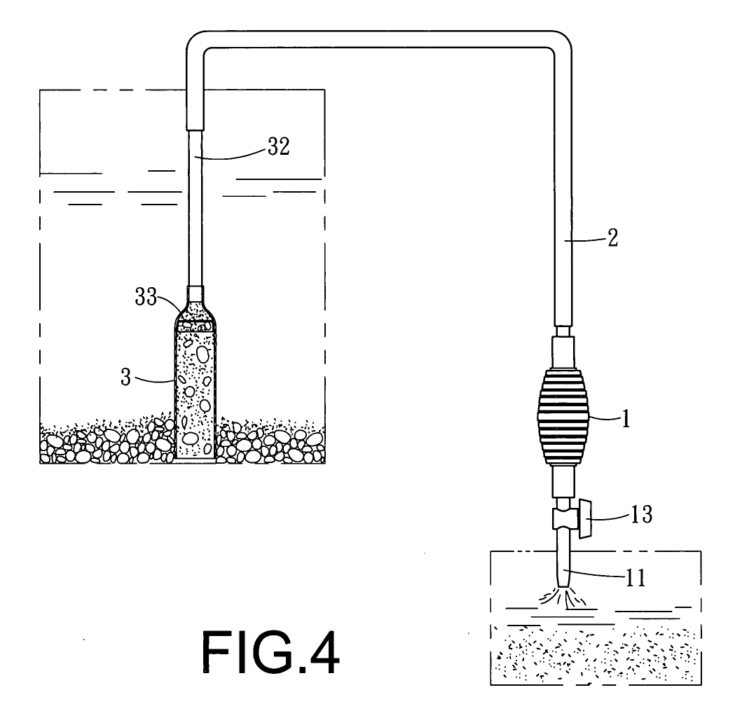

In using, as shown in FIG. 4, when the dirty water in an aquarium is to be replaced with clean one, put the flexible long tube 2 into the aquarium first and the open end of the residue collector 3 is inserted among the stone on the bottom of the aquarium, and then compress repeatedly the compressing ball 1 until the water in the aquarium starts to flow out, and then the dirt accumulated on the stones sucked out together with the water in the aquarium will automatically keep flowing out through the flexible tube, the compressing ball and the adjustable switch and out of the aquarium in accordance to suction theory, with the compressing ball no longer needed to be compressed. If the flow rate of water is to be altered, just rotate the adjustable stopcock 13 to change the angle of the passage 131 of the shank 132 in various ways for controlling the flow rate. If the adjustable switch 13 is temporarily and absolutely closed for a while, the flexible long tube 2 is still filled with water. So when the adjustable switch 13 is opened again, the water in the aquarium will keep on flowing again without necessity of re-compressing the compressing ball 1 because the water is still full of the tube 2 due to the suction theory, and starts to flow out again. If the residue accumulated on the bottom of the aquarium is to be cleaned up, just get the residue collector 3 connected with the duct 32 linked with the flexible long tube 2 and, then, insert the open end of the residue collector 3 into stones on the bottom of the aquarium where residue dominant congeries exist. Next, compress repeatedly the compressing ball 1 to let the water in the aquarium begin to flow out and suck up the dirt mixed in the water through the flexible tube 2 to the outside, achieving clean-up of the aquarium.

While the preferred embodiment of the invention has been described above, it will be recognized and understood that various modifications may be made therein and the appended claims are intended to cover all such modifications that may fall within the spirit and scope of the invention.

What is claimed is:

1. A dirt sucker for an aquarium comprising:
a compressing ball connected with a short tube at its two ends respectively, each of said short tubes having a valve inside it at spot where it is connected with said compressing ball, said compressing ball controlling water sucked in to flow only in one direction, one of said short tubes connected with an adjustable switch having a shank with a passage formed in a lower portion, said switch controlling flow rate and temporarily stopping suction;
a flexible long tube connected with one of said short tubes at one end;
a residue collector connected with said flexible long tube to indirectly link to said compressing ball and having a filter inside it; and,
said adjustable switch turned for various angles for controlling the flow rate of dirty water to be replaced in an aquarium, an open end of said residue collector inserted in said aquarium among stoned placed on the bottom of said aquarium for letting dirt accumulated on the stones sucked out together with water orderly through said flexible long tube, said compressing ball and said adjusting switch and exhausted out of said aquarium by repeatedly compressing of said compressing ball until the water in said aquarium begins to flow out.

2. A dirt sucker for an aquarium as claimed in claim 1, wherein said residue collector has a connecting head at one end for connecting with a duct to connect with said flexible long tube, and plural projections formed on its inner wall for fixing stably said filter with said residue collector.
